(19) United States
(12) Patent Application Publication
(10) Pub. No.: US 2016/0027044 A1
(43) Pub. Date: Jan. 28, 2016

(54) PRESENTING INFORMATION CARDS FOR EVENTS ASSOCIATED WITH ENTITIES

(71) Applicant: Google Inc., Mountain View, CA (US)

(72) Inventors: Matthew Sharifi, Palo Alto, CA (US); David Petrou, Brooklyn, NY (US)

(21) Appl. No.: 14/555,111

(22) Filed: Nov. 26, 2014

Related U.S. Application Data
(63) Continuation-in-part of application No. 14/135,080, filed on Dec. 19, 2013.

(51) Int. Cl. G06Q 30/02

(52) U.S. Cl. CPC G06Q 30/0251

(57) ABSTRACT

Methods, systems, and apparatus include computer programs encoded on a computer-readable storage medium, including a method for providing content. Snapshots associated with use of a computing device by a user are received. Each snapshot is based on content presented to the user. The snapshots are evaluated. For each respective snapshot, a respective set of entities indicated by the respective snapshot is identified. Indications of the respective set of entities and a respective timestamp indicating a respective time that the respective snapshot was captured are associated and stored. Based on a first snapshot of the snapshots, a first time to present one or more information cards to the user is determined. At the first time, entities having a time stamp that corresponds to the first time are located. An information card is generated based on the located entities. The generated information card is provided for presentation to the user.

### CROSS-REFERENCE TO RELATED APPLICATIONS

This application is a continuation-in-part of and claims priority to U.S. application Ser. No. 14/135,080, filed on Dec. 19, 2013, the entire contents of which are hereby incorporated by reference.

### BACKGROUND

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

### SUMMARY

In general, one innovative aspect of the subject matter described in this specification can be implemented in methods that include a computer-implemented method for providing content. The method can include receiving, by a server device, a plurality of snapshots associated with use of a computing device by a user, each snapshot from the plurality of snapshots being based on content presented to the user on the computing device. The method can further include evaluating the plurality of snapshots, including, for each respective snapshot: identifying a respective set of entities indicated by the respective snapshot, and storing, to a memory, indications of the respective set of entities and a respective timestamp indicating a respective time that the respective snapshot was captured, wherein the respective set of entities and respective timestamp are associated in the memory. The method can further include determining, based on a first snapshot from the plurality of snapshots, a first time to present one or more information cards to the user. The method can further include, at the first time, locating in memory entities having a time stamp that corresponds to the first time. The method can further include generating an information card based on the one or more of the located entities. The method can further include providing, for presentation to the user, the generated information card.

### BRIEF DESCRIPTION OF THE DRAWINGS

FIG. 1 is a block diagram of an example environment for delivering content.

FIG. 2A shows an example system for presenting information cards based on entities associated with snapshots of content presented to users.

FIG. 2B shows an example information card associated with a phone number entity.

FIG. 2C shows an example information card associated with a location entity.

FIG. 2D shows an example information card associated with a subject entity.

FIG. 3 is a flowchart of an example process for providing information cards based on snapshots extracted from content presented to a user.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for providing an information card or other form of notification determined based on one or more evaluated snapshots of content presented to a user. Snapshots, can be captured and evaluated on an ongoing basis based on content that is presented to one or more users on their respective user devices. Content may be presented to a user in, for example, a browser, an application (e.g., a mobile app), a web site, an advertisement, a social network page, or other digital content environments. Each snapshot may include at least a portion of one or more of a calendar entry, a map, an email message, a social network page entry, a web page element, an image, or some other content. Evaluating a particular snapshot can include identifying associated entities, (e.g., persons, places (e.g., specific locations, addresses, cities, states, countries, room numbers, buildings, or other specific geographic locations), things (such as phone numbers), subjects, scheduled events (e.g., lunch dates, birthdays, meetings), or other identifiable entities. A timestamp associated with receipt of a snapshot can also be stored in association with the snapshot and/or entities upon which the snapshot is based. Target presentation times can be determined, based on, for example a timestamp associated with receipt of the snapshot, and/or based on times of one or more events identified using the snapshot. At times corresponding to the target presentation times, one or more information cards that identify one or more of the entities can be provided (e.g., for presentation to the user). Each information card can also indicate, for example, a context that the user can use to understand the rationale for the display of the given information card. At least one call to action can also be included in the information card, to, for example, allow the user to perform an action associated with an entity (such as dialing a phone number, obtaining driving directions, or receiving additional information). An information card can serve as a prompt of sorts (e.g., for the user to remember a concept and/or some other piece(s) of information), or the information card can serve as a reminder of an upcoming event.

For situations in which the systems discussed here collect and/or use information including personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized to where location information is obtained (such as to a city, ZIP code, or state level), so that a particular location of a user cannot be determined.

Particular implementations may realize none, one or more of the following advantages. Users can be automatically presented with an information card that is relevant to an event or a subject associated with content that they have received.

The details of one or more implementations of the subject matter described in this specification are set forth in the accompanying drawings and the description below. Other features, aspects, and advantages of the subject matter will become apparent from the description, the drawings, and the claims.

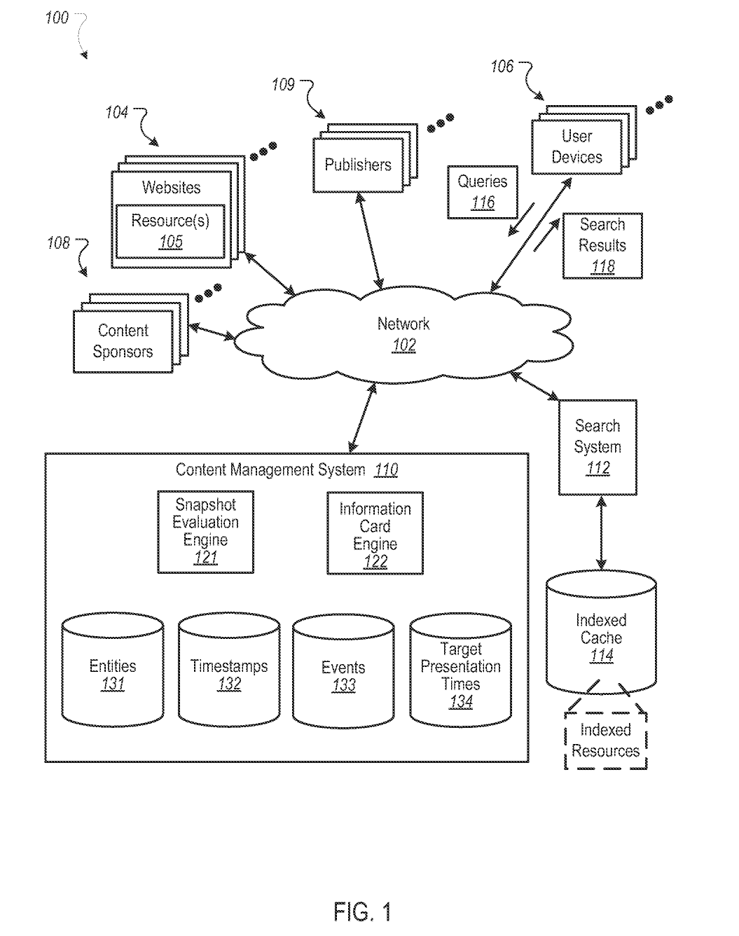

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

The environment 100 can include plural data stores, which can be stored locally by the content management system 110, stored somewhere else and accessible using the network 102, generated as needed from various data sources, or some combination of these. A data store of entities 131, for example, can include a list of entities that can be used to identify entities in snapshots of content presented to users. Entities can include, for example, phone numbers, locations (e.g., addresses, cities, states, countries, room numbers, buildings, specific geographic locations), subjects (e.g., related to topics), names of people, scheduled events (e.g., lunch dates, birthdays, meetings), email addresses, organization names, products, movies, music, or other subjects that can be represented, e.g., in a knowledge graph or other information representation.

A data store of entities 131 can include, for example, plural entries, one for each snapshot evaluated. A snapshot can be evaluated after capture and one or more top ranked or most significant entities that are included or referenced in a snapshot can be stored as a group (e.g., an entry in the data store of entities 131).

A data store of timestamps 132, for example, can include timestamps associated with times that respective snapshots were captured. The timestamps can be associated with the entities that are identified from the respective snapshots.

A data store of events 133, for example, can include information associated with events that have been identified from a respective snapshot. For example, information for an event can include one or more of a date, a start time, an end time, a duration, names of participants, an associated location, associated phone numbers and/or other contact information (e.g., email addresses), an event type (e.g., meeting, birthday, lunch date), and a description or context (e.g., that was obtained from the respective snapshot).

A data store of target presentation times 134, for example, can include one or more times that are established, by the content management system 110, for the presentation of a respective information card. For example, a target presentation time established for a lunch date may include a time that is one hour before the lunch date (e.g., as a reminder to leave or prepare for the lunch date) and a designated time on the day or night before the lunch date to inform the user of the next day's lunch date. Some or all of the data stores discussed can be combined in a single data store, such as a data store that includes a combination of identified entities, events, timestamps and target presentation times, all being associated with a single snapshot.

The content management system 110 can include plural engines, some or all of which may be combined or separate, and may be co-located or distributed (e.g., connected over the network 102). A snapshot evaluation engine 121, for example, can evaluate snapshots of content presented to a user on a device. For each snapshot, for example, the snapshot evaluation engine 121 can identify entities and/or events included in the snapshot and store the identified entities/events along with a timestamp associated with a time that a respective snapshot was captured or presentation time.

An information card engine 122, for example, can perform functions associated with gathering information for use in information cards, generating the information cards, and determining times for presenting the information cards. For example, after the received snapshots are evaluated, the information card engine 122 can determine content for inclusion in an information card and a time to present one or more information cards to the user, including determining a target time for the presentation. Selection of content and timing of presentation is discussed in greater detail below.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions.

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. Search results pages can also include one or more slots in which other content items (e.g., advertisements) can be presented.

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In addition, when no search is performed or no keywords are available (e.g., because the user is not browsing a webpage), other information, such as information obtained from one or more snapshots, can be used to respond to the received request. In some implementations, the selection of the eligible content items can further depend on user signals, such as demographic signals, behavioral signals or other signals derived from a user profile.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

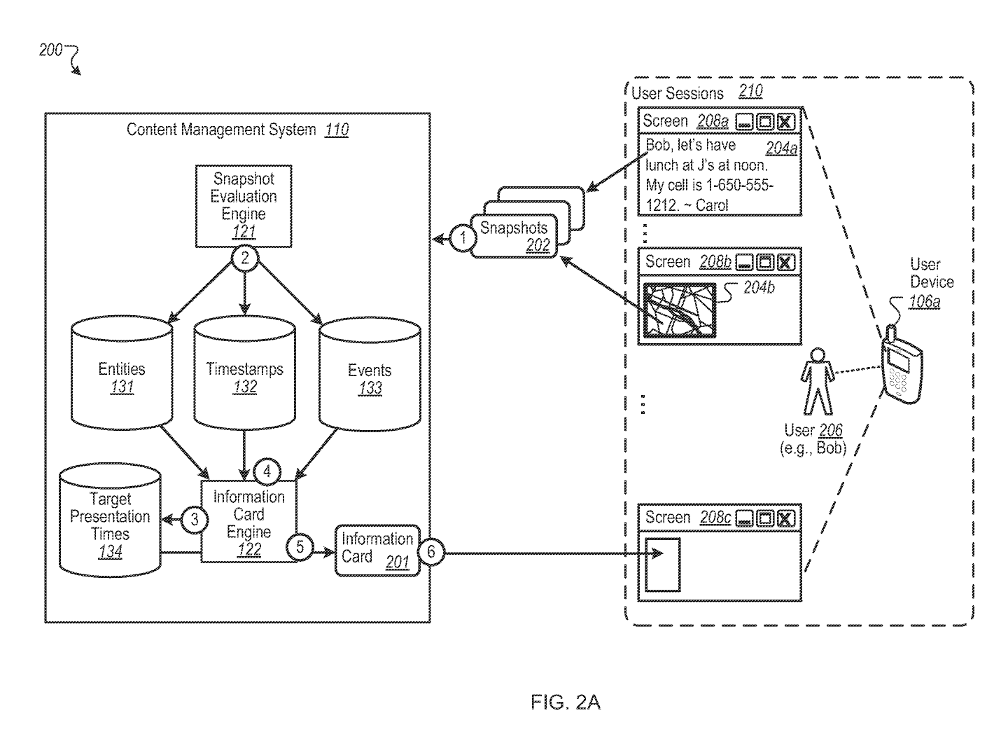

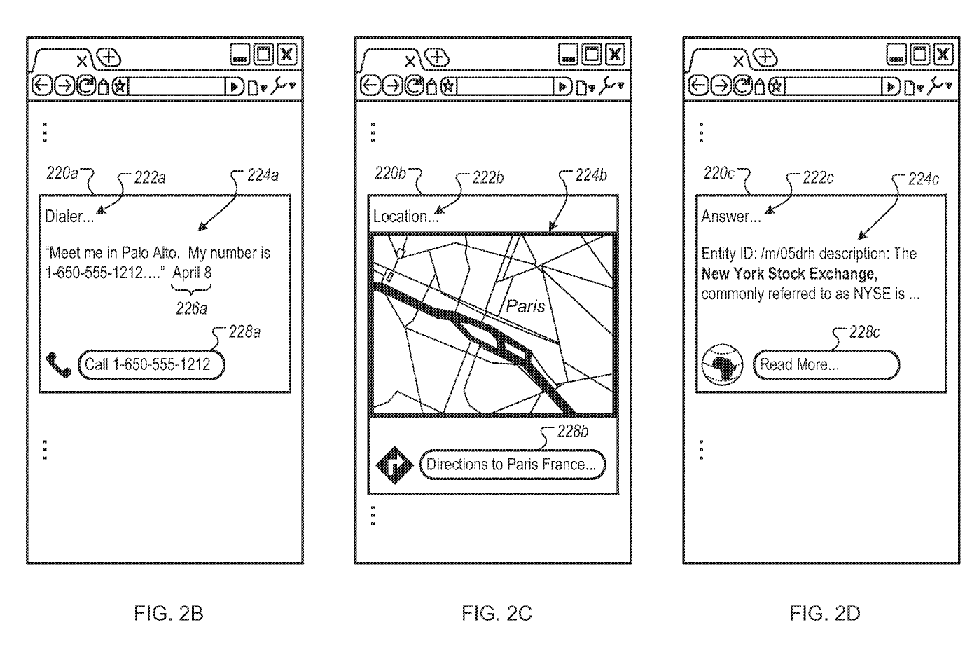

FIG. 2A is a block diagram of a system 200 for presenting information cards 201 based on entities associated with snapshots 202 of content presented to users. For example, snapshots 202 can be captured over time from content 204a, 204b that is presented to a user 206 on a user device 106a. The content 204a, 204b can be all or a portion of content (e.g., only content in active windows) in a display area associated with a user device. The content 204a, 204b may be presented in one or more of a browser, an application, a web site, an advertisement, a social network page, or some other user interface or application. The content 204a, 204b, for example, can include one or more of a calendar entry, a map, an email message, a social network page entry, a web page element, an image, or some other content or element. The snapshots 202 of the content 204a, 204b can be evaluated, for example, to identify associated entities 131, such as phone numbers, locations (e.g., addresses, cities, states, countries, room numbers, buildings, specific geographic locations), subjects, names of people, scheduled events (e.g., lunch dates, birthdays, meetings), or other identifiable entities. Timestamps 132 associated with the received snapshots 202 can be used with the identified entities 131, for example, to identify target presentation times 133 of information cards 201 associated with the entities 131. At times corresponding to the target presentation times 133, for example, the content management system 110 can provide information cards 201 for presentation to the user 206.

In some implementations, one or more events (e.g., a lunch date) can be identified based on the entities included in a snapshot (e.g., a calendar entry identifying a person, place and phone number). A first time (e.g., in the future) can be determined as to when the event is to occur (e.g., the lunch date meeting time), and the event can be stored (e.g., in the repository of events 133) along with the first time. A second time that is before the event can be determined, such as a time by which the user 206 needs to be notified to leave in order to arrive at the event on time. Generally, the second time can be a time to perform an action relative to the event before the event is to occur, such as ordering flowers for an anniversary or sending a card for a birthday. Determining a time to present an information card (e.g., associated with the lunch date) can include determining that a current time (e.g., the present time) is equal to the second time (e.g., an hour before the lunch date). The information card can be presented for the event at the second time. In some implementations, the following example stages can be used for providing information cards.

At stage 1, for example, the content management system 110 can receive the snapshots 202, e.g., a plurality of snapshots that are associated with a use of the user device 106a by a user 206. For example, the received snapshots 202 can include snapshots of content 204a, 204b presented to the user 206 on the user device 106a. The snapshots 202, for example, can include snapshots taken from an email message (e.g., content 204a) or from an image (e.g., content 204b), and/or from other content presented to the user 206.

At stage 2, for example, the snapshot evaluation engine 121 can evaluate the received snapshots 202. For example, for each snapshot, the snapshot evaluation engine 121 can identify entities 131 included in a snapshot 202. The entities that are identified for the snapshot 202 obtained from the content 204a, for example, can include Bob, Carol, J's restaurant, and Carol's cell phone number. The snapshot evaluation engine 121 can store the identified entities (or a subset thereof, such as most prominent entities) along with a timestamp associated with a time that a respective snapshot was captured. In some implementations, as part of the determining entities process, a determination can be made whether any determined entities are related to each other, such as related to a common event. Relatedness can be based on proximity (e.g., the entities appear in close proximity to each other) or some other relationship in the snapshot. In some implementations, timestamps can be stored in the data store of timestamps 132, e.g., for later use in generating and presenting information cards 201 related to the snapshots 202. In some implementations, one or more entities may be associated with an event. That is, an entity may be a person, and the event may relate to a meeting with the person (as indicated by the content included in an email message that is shown in the snapshot being evaluated). When an event is identified by the snapshot evaluation engine 121, a calendar item can be set up in the user's calendar and optionally in calendars of other users associated with the event (e.g., including users who are not necessarily event attendees). In some implementations, events that are identified can include events for which the user is not to attend, but from which the user may still benefit by received an information card (e.g., a coupon expiration for an on-line sale). Events are discussed in more detail below.

Evaluation of the snapshot 202 associated with the content 204a, for example, can determine that a lunch date event exists between the user 206 (e.g., Bob) and Carol. Other information identified from the snapshot 202 can include time, location information, and a phone number. In this example, entities that are identified can include Bob, Carol, the restaurant (e.g., J's), and Carol's phone number. As part of the snapshot evaluation, a context can be determined associated with the snapshot and/or event. For example, based on the entities of Bob, Carol, the restaurant and Carol's phone number, a context of “lunch date at noon on date X with Carol at J's.” Context information can be determined, stored and later accessed, for example, to provide a user with information as to why a particular information card was presented. In some implementations, other information can be included in a context, such as identification of the app or other source from which the snapshot was extracted, the way that the information was evaluated, or a context associated with a screen shot. In some implementations, the context information can be in the form of a snippet of text from which the entity or event was extracted. In some implementations, when the context information is subsequently presented, for example, the snippet on which the context is based can be formatted to highlight the relevant pieces of information.

At stage 3, for example, after one or more of the received snapshots are evaluated, the information card engine 122 can determine a time to present one or more information cards to the user including determining a target time. In some implementations, target times can be stored in the data store of target presentation times 134. For example, for Bob's pending lunch date with Carol, the information card engine 122 can determine a reminder time for Bob that is one hour before the scheduled noon lunch date. In some implementations, multiple times to present information cards can be determined, e.g., to include a reminder, to be sent the night before, that Bob has a lunch date with Carol the following day. In some implementations, target times can be determined using various factors, such as a mode of transportation, a distance, a location and/or other factors. For information cards that serve as prompts to the user, for example, target times can include one or more times since the concept was originally presented to the user, e.g., in the form of content from which a respective snapshot was obtained.

At stage 4, for example, the information card engine 122 can identify entities from the stored entities 131 based on a comparison of the target time with timestamps associated with a respective entity of the stored entities. For example, for the lunch date that is scheduled for Carol and Bob, the information card engine 122 can identify information to be used in an information card that is associated with the pending lunch date. For example, Carol's phone number can be an entity that can be identified for the generation of the information card, e.g., for a reminder to Bob that is sent at a target time one hour before the lunch date and that also includes Carol's cell phone number.

At stage 5, for example, the information card engine 122 can generate the information card 201 based on the one or more identified entities 131. For example, information card 201 can include information associated with the lunch date and Carol's cell phone number. In some implementations, the information card 201 can be stored, e.g., at the content management system 110, for use in multiple subsequent presentations of the same information card.

At stage 6, for example, the content management system 110 can provide, for presentation to the user, the information card 201. For example, the information card 201 may be provided to the user device 106a for presentation on a screen 208c, which may be the same or different screen as screens 208a, 208b from which the snapshots 202 were obtained from plural user sessions 210 for the user 206. In some implementations, the screens 208a, 208b, 208c can be screens that are presented on multiple ones of user devices 106a that are associated with the user 206. The time at which the information card is presented, for example, can be a time since the concept associated with the information card was originally presented to the user, e.g., in the form of content from which a respective snapshot was obtained. In this example, the information card can be provided to jog the user's memory. The time at which the information card is presented, for example, can also be a time relative to an event (e.g., the lunch date) that is associated with the information card.

In some implementations, some information cards 201 may be applicable to more than one user. For example, the content management system 110 can provide information cards 201 to all parties associated with an event, such as to both Bob and Carol with regard to their pending lunch date.

In some implementations, when snapshots are evaluated in anticipation of potentially providing information cards to the user, the user can optionally receive a notification (e.g., along the lines of “You may be receiving information cards based on X . . . ”). In some implementations, users can have an option to change when and how information cards are to be presented, either individually by groups (or by types of information cards), or globally. In some implementations, users can be presented with controls for specifying the type of information that can be used for information cards, such as checkbox controls along the lines of “Don't use information from my email to generate information cards.” In some implementations, users can control the times that information cards are to be presented, e.g., times of day or times for specific snapshots. In some implementations, users can be provided with transparency controls for any particular information card, e.g., to learn how or why an information card was prepared and presented.

FIG. 2B shows an example information card 220a associated with a phone number entity. For example, continuing the example described above with respect to FIG. 2A, the information card 220a can be presented an hour before Bob and Carol's pending lunch date. The information card 220a can include, for example, a notification caption 222a (e.g., “Dialer . . . ”) that notifies the user that the information card is a type that is associated with a phone number, e.g., Carol's cell phone number. A context 224a, for example, can identify the context associated with the information card. In this example, the context 224a can include (or be determined from) part of the snapshot 202, including a snippet of Bob's email message received from Carol that contains information (e.g., location, phone number, date 226a) associated with the pending lunch date. The information card 220a can also include, for example, a call-to-action 228a, such as a control, displayed with the information card on Bob's smart phone, for dialing Carol's cell phone number). Other calls-to-action 228a are possible in this example, such as a call-to-action to display a map to the restaurant.

FIG. 2C shows an example information card 220b associated with a location entity. The information card 220b can include, for example, a notification caption 222b (e.g., “Location . . . ”) that notifies the user that the information card is associated with a location, e.g., Paris, France. The information card 220b can be generated, for example, from a snapshot 202 associated with the user browsing online information associated with Paris, such as online travel or vacation information. A context 224b, for example, can identify the context associated with the information card. In this example, the context 224b can include (or be determined from) part of the snapshot 202, including a map that may be included in a snapshot or identified from information in the snapshot. The information card 220b can also include, for example, a call-to-action 228b, such as a control, displayed on Bob's smart phone, for obtaining driving directions to or within Paris. A time associated with the presentation of the information card 220b can be determined based on a present time and the user's current location (e.g., arriving at an airport in Paris).

FIG. 2D shows an example information card 220c associated with an informational entity. The information card 220c can include, for example, a notification caption 222c (e.g., “Answer . . . ”) that notifies the user that the information card is associated with a subject, e.g., the New York Stock Exchange (NYSE). In this example, the NYSE can also be a location. “Answer” types of information cards can apply, for example, to informational entities, e.g., from a snippet, a biography, a quote (e.g., a stock quote displayed on the user's screen), or other informational content. The information card 220c can be generated, for example, from a snapshot associated with the user browsing online information associated with the NYSE or information from other sources. A context 224c, for example, can identify the context associated with the information card. In this example, the context 224c can include (or be determined from) part of the snapshot, including a snippet of text about the NYSE that the user may have been presented as content from a web site. The information card 220c can also include, for example, a call-to-action 228c, such as a control, displayed on Bob's smart phone, for obtaining more information about the NYSE.

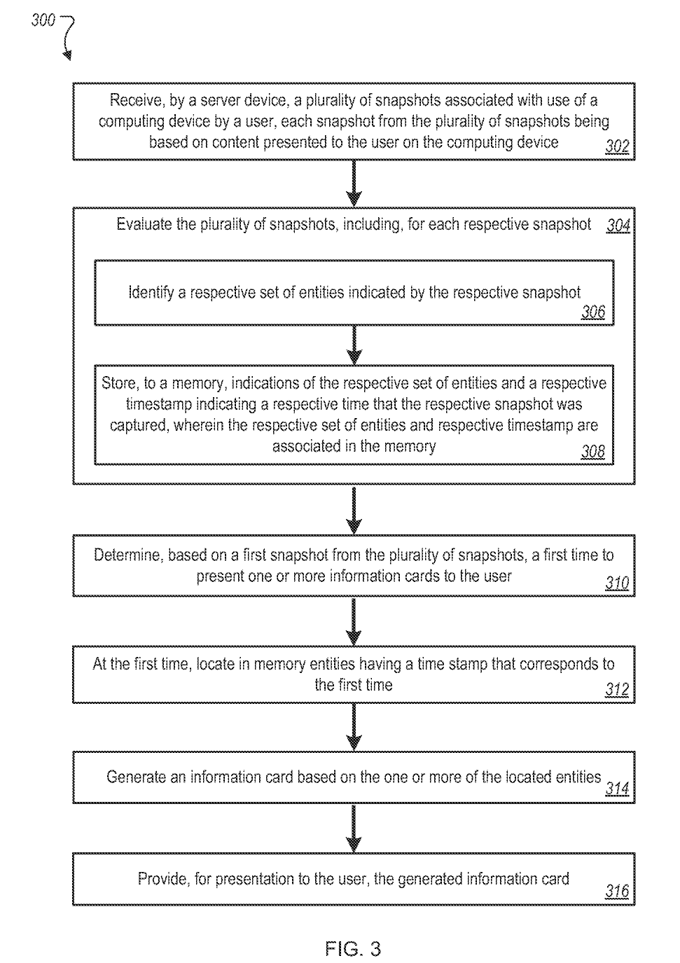

FIG. 3A is a flowchart of an example process 300 for providing information cards based on snapshots extracted from content presented to a user. For example, coincidence can include simultaneous, near simultaneous or recent presentation of the sensory content item to a user. In some implementations, the content management system 110 can perform stages of the process 300 using instructions that are executed by one or more processors. FIGS. 1-2C are used to provide example structures for performing the steps of the process 300.

A plurality of snapshots associated with use of a computing device by a user is received by a server device (302). Each snapshot from the plurality of snapshots is based on content presented to the user on the computing device. For example, a server device, such as the content management system 110, can receive snapshots 202 associated with use of the user device 106a, including snapshots 202 of content 204a, 204b presented to the user 206.

In some implementations, the process 300 can further include obtaining the plurality of snapshots by the device. For example, the user device 106a can take the snapshots 202 and provide them to the content management system 110. In some implementations, the snapshots 202 can be obtained by the content management system 110 from the content that the content management system 110 provides to the user device 106a.

In some implementations, the snapshots associated with the use of the device by the user can include audio presented to, or experienced by, the user. For example, snapshots 202 can include recordings that have been provided to the user device 106a. In this example, the obtaining the snapshots 202 can also include using voice recognition or other recognition techniques to obtain a textual translation or identification (e.g., title) of the audio that is presented. In some implementations, obtaining the snapshot 202 can include obtaining an audio fingerprint (e.g., of a particular song) for use in identifying the audio.

In some implementations, snapshots associated with the use of the device by the user can include content that is not associated with a browser. As an example, snapshots 202 can be obtained from non-browser sources such as applications, web sites, social network sites, advertisements, and/or other sources.

In some implementations, obtaining the plurality of snapshots by the device can occur periodically or based on an environmental event. For example, snapshots 202 can be obtained periodically, such as at N-second or M-minute intervals, or snapshots 202 can be obtained whenever certain triggers occur, e.g., including user actions or other triggers. In some implementations, the environmental event can be triggered by the device (e.g., the user device 106a), by an application (e.g., when the user starts the app or performs a triggering action), by a service (e.g., map application, calendar, or email) communicating with the device, by the operating system associated with the device, or based on a change of context, change of scene, or change of use of the device by the user. For example, a new snapshot 202 can occur when it is determined that a threshold percentage of the screen on the user device 106a has changed.

In some implementations, the environmental event can be a change in context of an application that is executing on the device, wherein a time used for detecting the change of context includes at least one of a substantially current time and a previous time. For example, the environmental event can be triggered by the user 206 moving from one level of an application or game to another level, or by reaching a milestone associated with the application or game. The change of context (e.g., change of levels or reaching a milestone) can be determined, e.g., by comparing contexts at a previous time and the current time.

The plurality of snapshots are evaluated (304). The snapshot evaluation engine 121, for example, can evaluate the received snapshots 202. For example, the snapshot evaluation engine 121 can identify, for each snapshot, entities 131 included in a snapshot 202. The snapshot evaluation engine 121 can store the identified entities along with a timestamp associated with a time that a respective snapshot was captured.

In some implementations, receiving the snapshots associated with use of the device by the user can include receiving a hash that represents the content included in a respective snapshot, and evaluating the received snapshots includes using, in the evaluating, the hash instead of original content. For example, instead of (or in addition to) evaluating the snapshot 202, the snapshot evaluation engine 121 can evaluate hash information associated with the content provided. The information can include, for example, text that corresponds to the content (e.g., “your credit card ending *1437”), or metadata associated with the content that describes what is contained in the content (e.g., “your address plus ZIP”).

In some implementations, evaluating the received snapshots can further include identifying one or more events based on the entities included in a snapshot, determining a first time that is in the future when the event is to occur, storing the event along with the first time, determining a second time that is before the event, and determining the time to present can include determining that a current time is equal to the second time and presenting an information card includes presenting an information card for the event at the second time. For example, as described above with respect to FIG. 2A, evaluating the snapshot 202 can indicate the existence of a lunch date event between Bob and Carol. The time/place of the lunch date and Carol's cell phone number can also be determined from the snapshot 202. The content management system 110 can use this information to identify the lunch date and to generate one or more information cards at predetermined times before the lunch date is to occur.

In some implementations, identifying entities included in the snapshot can further include identifying a natural language description of an event in the text. For example, the snapshot evaluation engine 121 can identify text in the content 204a that describes the event (e.g., a lunch date) or indicates the entities associated with the event (e.g., Bob, Carol, J's restaurant, and Carol's phone number).

In some implementations, the event can be an activity of interest to the user that is to occur in the future. As an example, the event that is identified by the snapshot evaluation engine 121 can be the lunch date that Bob has with Carol, which is of interest to Bob.

For each respective snapshot, a respective set of entities indicated by the respective snapshot is identified (306). For example, the snapshot evaluation engine 121 can identify entities 131 included in the snapshot 202 obtained from the content 204a. The entities that are identified for the snapshot 202, for example, can include Bob, Carol, J's restaurant, and Carol's cell phone number.

Indications of the respective set of entities and a respective timestamp indicating a respective time that the respective snapshot was captured are stored to a memory (308). The respective set of entities and respective timestamp are associated in the memory. As an example, the snapshot evaluation engine 121 can store the most prominent identified entities along with a timestamp associated with a time that a respective snapshot was captured. The timestamps can be stored, for example, in the data store of timestamps 132 for later use in generating and presenting information cards 201 related to the snapshots 202 and associated entities.

Based on a first snapshot from the plurality of snapshots, a first time to present one or more information cards to the user is determined (310). For example, the information card engine 122 can determine a time to present one or more information cards to the user including determining a target time. For example, for Bob's pending lunch date with Carol, the information card engine 122 can determine a reminder time for Bob that is one hour before the scheduled noon lunch date. In some implementations, multiple times to present information cards can be determined, e.g., to include a reminder, to be sent the night before, that Bob has a lunch date with Carol the following day. For non-event snapshots that have been processed, such as a snapshot 202 obtained associated with the NYSE, the target time can be relative to the timestamp associated with the snapshot 202, such as to show the user the information card 220c at a later time. In some implementations, target times can be calculated closer to the start time of an event, or can be re-calculated based on a current location of the user who is to receive the information card (e.g., Bob may need 90 minutes to drive to the lunch date, based on Bob's current location).

In some implementations, the target time can be a time in the past, and the information card can provide a reminder for an event or entity surfaced to the user in the past. For example, the information card 220c can be based, not on an event, but on a past presentation of content related to the NYSE.

In some implementations, determining the time to present one or more information cards can include determining one or more predetermined times in the past and, for each time, determining one or more information cards for presentation to the user. For example, the information card engine 122 can determine multiple times to present the information card 220c, and the times can be based on when the user was first presented with content associated with the NYSE on which the information card 220c is based.

In some implementations, the predetermined times can be varied depending on a current context of the user. For example, based on the current actions of the user 206, e.g., being in the middle of an app or casually surfing the Internet, the information card engine 122 can delay or accelerate the generation of the data card (e.g., based on the user's current location). In some implementations, information cards can be surfaced when requested by the user, such as when opening an application or tool that displays and/or manages information cards, and/or by requesting that all or particular information cards be presented. Other signals for surfacing information cards can be used.

At the first time, entities having a time stamp that corresponds to the first time are located in memory (312). For example, the information card engine 122 can identify entities for use in generating an information card from the stored entities 131 based on a comparison of the target time with timestamps associated with a respective entity of the stored entities. For example, for the lunch date that is scheduled for Carol and Bob, the information card engine 122 can identify information to be used in an information card that is associated with the pending lunch date. For example, Carol's phone number can be an entity that is identified for the generation of the information card that includes a reminder to Bob. The information card can be sent at a target time one hour before the lunch date and can include Carol's cell phone number.

In some implementations, identifying entities can further include recognizing text in the snapshot, and parsing the text to identify entities. For example, the snapshot evaluation engine 121 can recognize that the snapshot 202 includes text. The snapshot evaluation engine 121 can extract the text in various ways, such as by using optical character recognition (OCR) or other character recognition techniques, by extracting text from Hyper-Text Markup Language (HTML) or other code used for generating the content (e.g., content 204a or 204b), or by other techniques. In some implementations, recognizing text in a snapshot can include using natural language processing techniques, e.g., that use a grammar associated with words or phrases in the text, or sources of snapshots (e.g., based on email formats, calendar entry formats, or other formats). In some implementations, other visual recognition techniques can be applied to the snapshots, e.g., object recognition, landmark recognition, and/or other ways to detect entities from images.

An information card is generated based on the one or more of the located entities (314). For example, the information card engine 122 can generate the information card 201 including the one or more identified entities 131 (e.g., an information card that includes Carol's cell phone number).

The generated information card is provided for presentation to the user (316). For example, once the information card 201 is generated, the information card 201 may be presented multiple times, for example, on the screen 208c of the user device 106a.

In some implementations, storing the identified entities can include storing contextual information associated with an identified entity, and presenting the information card can further include presenting the contextual information along with information about the identified entity on the information card. For example, then the snapshot 202 is evaluated by the snapshot evaluation engine 121, information can also be determined and stored for context information that a context associated with a respective snapshot that includes the entities (e.g., identifies the email message and the pending lunch date). At the time that the information card 201 is provided for presentation, for example, the information card 201 can include the context 224a (e.g., identifying the lunch date email or associated information). Other example contexts are shown in contexts 224b and 224c.

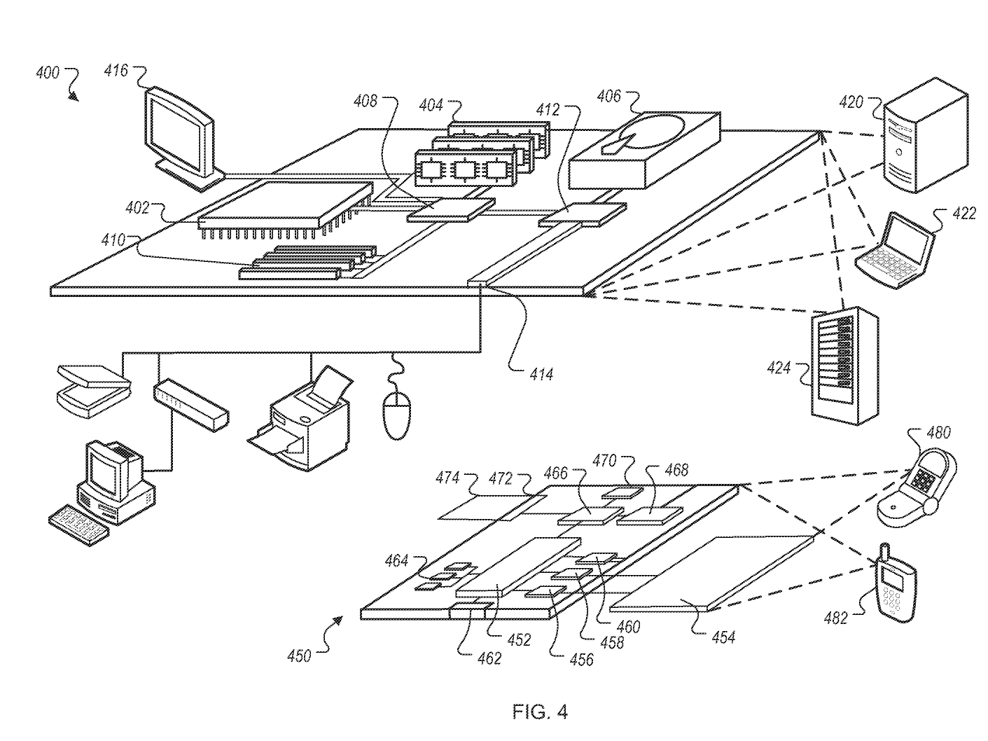

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the technologies described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any technologies or of what may be claimed, but rather as descriptions of features specific to particular implementations of particular technologies. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by a server device, a plurality of snapshots associated with use of a computing device by a user, each snapshot from the plurality of snapshots being based on content presented to the user on the computing device;
evaluating the plurality of snapshots, including, for each respective snapshot:
identifying a respective set of entities indicated by the respective snapshot; and
storing, to a memory, indications of the respective set of entities and a respective timestamp indicating a respective time that the respective snapshot was captured, wherein the respective set of entities and respective timestamp are associated in the memory;
determining, based on a first snapshot from the plurality of snapshots, a first time to present one or more information cards to the user;
at the first time, locating in memory entities having a time stamp that corresponds to the first time;
generating an information card based on the one or more of the located entities; and
providing, for presentation to the user, the generated information card.

2. The method of claim 1 wherein:
evaluating the received snapshots further includes identifying one or more events based on the entities included in a snapshot, determining a first time that is in the future when the event is to occur, storing the event along with the first time, determining a second time that is before the event, and
determining the time to present includes determining that a current time is equal to the second time and providing an information card includes providing an information card for the event at the second time.

3. The method of claim 2 wherein identifying entities included in the snapshot further includes identifying a natural language description of an event in the text.

4. The method of claim 2 wherein the event is an activity of interest to the user that is to occur in the future.

5. The method of claim 1 wherein:
the target time is a time in the past, and
the information card provides a reminder for an event or entity surfaced to the user in the past.

6. The method of claim 1 wherein storing includes storing contextual information associated with an identified entity and wherein providing further includes providing the contextual information along with information about the identified entity on the information card.

7. The method of claim 1 wherein identifying entities included in the snapshot further includes recognizing text in the snapshot, and parsing the text to identify entities.

8. The method of claim 1 wherein determining a time to present one or more information cards includes determining one or more predetermined times in the past and, for each time, determining one or more information cards for presentation to the user.

9. The method of claim 8 wherein the predetermined times are varied depending on a current context of the user.

10. The method of claim 1 further comprising obtaining the plurality of snapshots by the device.

11. The method of claim 10 wherein obtaining snapshots occurs periodically or based on an environmental event.

12. The method of claim 11 wherein the environmental event is triggered by the device, by an application, by a service communicating with the device, by the operating system associated with the device, or is based on a change of context, change of scene, or change of use of the device by the user.

13. The method of claim 12 wherein:
the environmental event is a change in context of an application that is executing on the device, and
a time used for detecting the change of context includes at least one of a substantially current time and a previous time.

14. The method of claim 1 wherein the snapshots associated with the use include audio presented to or experienced by the user.

15. The method of claim 1 wherein the snapshots associated with the use include content that is not associated with a browser.

16. The method of claim 1 wherein receiving the snapshots associated with use includes receiving a hash that represents the content included in a respective snapshot, and wherein evaluating the received snapshots includes using, in the evaluating, the hash instead of original content.

17. The method of claim 1 wherein providing the information card includes providing a control for an associated user action selected from a group comprising a call, a navigation or an email.

18. A computer program product embodied in a non-transitive computer-readable medium including instructions, that when executed, cause one or more processors to:
receive, by a server device, a plurality of snapshots associated with use of a computing device by a user, each snapshot from the plurality of snapshots being based on content presented to the user on the computing device;
evaluate the plurality of snapshots, including, for each respective snapshot:
identifying a respective set of entities indicated by the respective snapshot; and
storing, to a memory, indications of the respective set of entities and a respective timestamp indicating a respective time that the respective snapshot was captured, wherein the respective set of entities and respective timestamp are associated in the memory;
determine, based on a first snapshot from the plurality of snapshots, a first time to present one or more information cards to the user;
at the first time, locate in memory entities having a time stamp that corresponds to the first time;
generate an information card based on the one or more of the located entities; and
provide, for presentation to the user, the generated information card.

19. A system comprising:
one or more processors; and
one or more memory elements including instructions that, when executed, cause the one or more processors to:
receive, by a server device, a plurality of snapshots associated with use of a computing device by a user, each snapshot from the plurality of snapshots being based on content presented to the user on the computing device;
evaluate the plurality of snapshots, including, for each respective snapshot:
identifying a respective set of entities indicated by the respective snapshot; and
storing, to a memory, indications of the respective set of entities and a respective timestamp indicating a respective time that the respective snapshot was captured, wherein the respective set of entities and respective timestamp are associated in the memory;
determine, based on a first snapshot from the plurality of snapshots, a first time to present one or more information cards to the user;
at the first time, locate in memory entities having a time stamp that corresponds to the first time;
generate an information card based on the one or more of the located entities; and
provide, for presentation to the user, the generated information card.

20. The system of claim 19 wherein evaluating the received snapshots further includes identifying one or more events based on the entities included in a snapshot, determining a first time that is in the future when the event is to occur, storing the event along with the first time, determining a second time that is before the event, and wherein determining the time to present includes determining that a current time is equal to the second time and providing an information card includes providing an information card for the event at the second time.
